(19) United States
(12) Patent Application Publication
(10) Pub. No.: US 2025/0135541 A1
(43) Pub. Date: May 1, 2025

(54) SYSTEM FOR HEATING OBJECTS DURING MANUFACTURE BY A METAL HYBRID MANUFACTURING SYSTEM

(71) Applicant: ADDiTEC, Palm City, FL (US)

(72) Inventors: Brian Matthews, Palm Beach Gardens, FL (US); Chu-heng Liu, Penfield, NY (US); Paul J. McConville, Webster, NY (US); Sriram Manoharan, West Palm Beach, FL (US)

(21) Appl. No.: 18/498,947

(22) Filed: Oct. 31, 2023

(51) Int. Cl. B22F 10/22; B22F 10/362; B33Y 30/00; B33Y 50/02

(52) U.S. Cl. CPC B22F 10/22; B22F 10/362; B33Y 30/00; B33Y 50/02

(57) ABSTRACT

A metal hybrid additive manufacturing apparatus includes a melted metal drop ejecting device and at least one other tool that are operated to form metal objects on a platform. An object heater is configured to direct heat toward the metal object being formed on the platform. The object heater can be a radiation heater, a convection heater, an infrared heater, an induction heater, and a focused energy source. The focused energy source can be integrated with the melted metal drop ejecting device.

### STATEMENT REGARDING FEDERALLY FUNDED RESEARCH OR DEVELOPMENT

Not Applicable.

### TECHNICAL FIELD

This disclosure is directed to hybrid manufacturing systems that produce three-dimensional (3D) objects and, more particularly, to operation of a heater in such systems.

### BACKGROUND

Three-dimensional printing, also known as additive manufacturing, is a process of making a three-dimensional solid object from a digital model of virtually any shape. Many three-dimensional printing technologies use an additive process in which an additive manufacturing device forms successive layers of the part on top of previously deposited layers. Some of these technologies use ejectors that eject UV-curable materials, such as photopolymers or elastomers. The printer typically operates one or more ejectors to form successive layers of the plastic material that form a three-dimensional printed object with a variety of shapes and structures. After each layer of the three-dimensional printed object is formed, the plastic material is UV cured and hardens to bond the layer to an underlying layer of the three-dimensional printed object. This additive manufacturing method is distinguishable from traditional object-forming techniques, which mostly rely on the removal of material from a work piece by a subtractive process, such as cutting or drilling.

3D object printers have been developed that eject drops of melted metal from one or more ejectors to form 3D objects. These devices have a source of solid metal, such as a roll of wire, pellets, billets, or ingots, that are fed into a heating chamber where they are melted and the melted metal flows into a chamber of the ejector. The chamber is made of non-conductive material around which an uninsulated electrical wire is wrapped. An electrical current is passed through the conductor to produce an electromagnetic field to cause the meniscus of the melted metal at a nozzle of the chamber to separate from the melted metal within the chamber and be propelled from the nozzle. A platform opposite the nozzle of the ejector is moved in a X-Y plane parallel to the plane of the platform by a controller operating actuators so the ejected metal drops form metal layers of an object on the platform and another actuator is operated by the controller to alter the position of the ejector or platform in the vertical or Z direction to maintain a constant distance between the ejector and an uppermost layer of the metal object being formed. This type of metal drop ejecting printer is also known as a magnetohydrodynamic (MHD) printer.

Most melted metal drop ejecting devices have a single ejector that operates at an ejection frequency in a range of about 50 Hz to about 3 KHz and that eject drops having a diameter of about 200 μm to about 700 μm with the higher ejection frequencies being used for the smaller drops. This firing frequency range and drop size extends the time required to form metal objects over the times needed to form objects made with metal or other alloy materials. Although some melted metal drop ejecting devices have one or more printheads or more than one nozzle fluidly coupled to a common manifold, they still are limited to these ejection frequencies and drop sizes. Three-dimensional object printers having multiple nozzles that form plastic objects and the like are known to use a single nozzle for formation of fine features or the perimeters of layers and then increase the number of nozzles used to infill the layer. By increasing the number of nozzles used, a greater amount of the thermoplastic material can be dispensed into the interior regions of a layer in a short amount of time to improve the production time for the objects manufactured by such printers. Maintaining an adequate supply of melted metal to multiple printheads or nozzles is difficult, especially if the number of nozzles being used is selectively varied during the object formation.

Other additive manufacturing devices have been developed that use deposition techniques for forming layers of a metal object. These systems include metal material supplies and focused heat beams or pneumatic pressure to deposit metal and form metal layers for a metal object. One such metal deposition device is a directed energy deposition (DED) device that typically includes a metal supply channel and a plurality of laser light fibers emanating from a plurality of laser light sources to produce a plurality of off-axis laser light beams that can meet at a focal point of a wire end, metal powder and the laser beams. The plurality of off-axis laser light beams concentrate the laser energy onto the wire and metal powder deposited at the focal point to form a metal spot to produce a layer-by-layer build-up of metal having a user-specified configuration and dimension. User-defined process parameters (e.g., deposition velocity, laser power, and wire/metal powder feed rate) are input into a customized computer process as control signals to drive the metal layer production process. Automated features, including wire feed rate and metal powder deposition rate, provide variable inputs for the optimization of layer quality.

Hybrid manufacturing systems have been developed that include one or more additive manufacturing devices and at least one subtractive manufacturing device to remove excess material or to finish the surface of an object formed with the additive manufacturing devices. These hybrid manufacturing systems have not included MHD printers or the like because the temperature of the melted metal ejected by such printers make the environment harsh. Typically, the object being formed by a MHD printer needs to be at a temperature of at least 500° C. for melted aluminum alloys. Other metals require even higher temperatures. However, melted metal drop ejecting devices can produce metal parts with higher resolution and offer many advantages over other technologies use to manufacture metal objects. Being able to operate or use melted metal drop ejecting devices to a hybrid manufacturing system to facilitate formation of metal objects by the system would be beneficial.

### SUMMARY

A new metal hybrid manufacturing system enables an object to be heated to the temperatures necessary for forming objects with melted metal drops without damage to the other components of the system. The system includes a platform, a melted metal drop ejecting device coupled to a member, the melted drop ejecting device being configured to eject discrete melted metal drops toward the platform to form a metal object on the platform, a tool coupled to the member, the tool being configured to either add metal or remove metal from the metal object being formed on the platform, and a controller operatively connected to the melted metal drop ejecting device and the tool. The controller is configured to: operate the melted metal drop ejecting device to form portions of the metal object on the platform; and operate the tool to either shape or form other portions of the metal object being formed on the platform.

Another embodiment of the new metal hybrid manufacturing system enables an object to be heated to the temperatures necessary for forming objects with melted metal drops without damage to the other components of the system. The method includes a platform; a member; a melted metal drop ejecting device mounted to the member, the melted metal drop ejecting device configured to eject discrete melted metal drops toward the platform to form a metal object on the platform; a tool mounted to the member, the tool being configured to either add or remove metal from the metal object on the platform; a heater configured to heat at least a portion of the metal object being formed on the platform; and a controller operatively connected to the melted metal drop ejecting device, the tool, and the heater. The controller is configured to: operate the melted metal drop ejecting device to form portions of a metal object on the platform; operate the heater to heat the metal object on the platform; and operate the tool to shape or form other portions of the metal object on the platform.

### BRIEF DESCRIPTION OF THE DRAWINGS

The foregoing aspects and other features of a metal hybrid manufacturing system and its operation that enables an object to be heated to the temperatures necessary for forming objects with melted metal drops without damage to the other components of the system are explained in the following description, taken in connection with the accompanying drawings.

FIG. 1 depicts a metal hybrid manufacturing system that operates a heating element in a platform to enable an object to be heated to the temperatures necessary for forming objects with melted metal drops without damage to the other components of the system.

FIG. 2 depicts a metal hybrid manufacturing system that operates a focused energy source to enable localized areas of an object to be heated to the temperatures necessary for forming objects with melted metal drops without damage to the other components of the system.

FIG. 3 depicts a metal hybrid manufacturing system that operates a focused energy source integrated within a melted metal drop ejecting device to enable localized areas of an object to be heated to the temperatures necessary for forming objects with melted metal drops without damage to the other components of the system.

### DETAILED DESCRIPTION

For a general understanding of the environment for the system and its operation as disclosed herein as well as the details for the device and its operation, reference is made to the drawings. In the drawings, like reference numerals designate like elements.

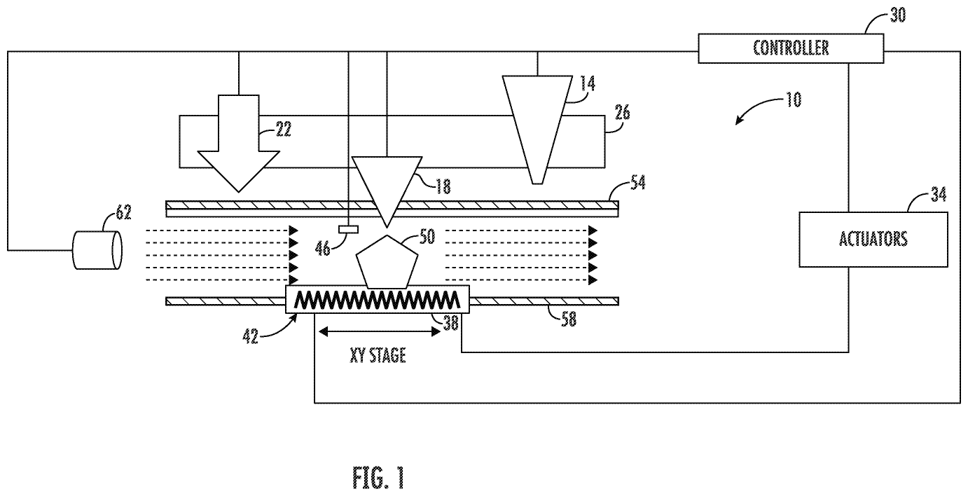

FIG. 1 illustrates an embodiment of a metal hybrid manufacturing system 10 that includes a metal deposition device 14, such as a DED device, a melted metal drop ejecting device 18, and a subtractive manufacturing device 22. These devices are mounted on a common frame or gantry 26. As used in this document, the term “metal deposition device” means an assembly of components that selectively deposits metal on a substrate or object and causes the deposited metal to bond to the substrate or part simultaneously or instantaneously. As used in this document, the term “melted metal drop ejecting device” means an assembly of components that melts solid metal and ejects drops of the melted metal onto a substrate or part. Examples of melted metal drop ejecting devices may include, conventional MHD ejectors, inductive MHD ejectors, an EHD liquid metal ejector, a mechanical or piezo-coupled piston driven ejectors, and pneumatic ejectors. As used in this document, the term “subtractive manufacturing device” means a tool that is configured to remove metal from an object being formed by a manufacturing system. A controller 30 is operatively connected to the devices 14, 18, and 22. The controller 30 includes a computer-readable, non-transitory storage media, such as an internal memory, or an external computer-readable, non-transitory storage media, such as electronic memory or the like, that stores programmed instructions that when executed by the controller cause the controller to operate the devices in a manner described more fully below. The controller 30 is also operatively connected to one or more actuators 34 that are operatively connected to the frame 26 and the platform 38. The controller 30 operates the one or more actuators 34 to move the platform 38 in an X-Y plane and move the frame 26 bidirectionally along a Z axis that is perpendicular to the X-Y plane when the controller executes programmed instructions in the internal or external memories.

The platform 38 in the embodiment shown in FIG. 1 includes a contact heating element 42 that is operated by the controller 30. Controller 30 is configured with programmed instructions stored in a non-transitory, computer readable medium so when the instructions are executed the controller generates signals for operating the heating element 42. For example, these signals selective couple and decouple the heating element to an electrical power source and operate the electrical power source to adjust the electrical power supplied to the heating element 42 to achieve predetermined surface temperatures on object 50 being formed on the platform 38. A non-contact temperature probe 46 is mounted to frame 26. Sensor 46 may generate a signal indicative of the temperature of the environment. In one embodiment, the sensor may be a pyrometer that generates a signal indicative of a local temperature of the location on the part where melted metal drops are being deposited. The probe 46 generates a signal indicative of the surface temperature of the object 50 on the platform 38. The probe 46 is operatively connected to the controller 30 and the controller 30 is configured to use the signal received from the probe 46 to operate the heating element 42 to keep the surface temperature of the object 50 within a predetermined range.

To retain the heat generated by the melted metal drops and the object, an upper heat shield 54 and a lower heat shield 58 are positioned above the object 50 and on the level with the platform 38. Also, heat shields extend between the heat shields 54 and 58 on either side of the object 50 to enclose the space about the object 50. The heat shields may be made with an appropriate material that retains its shape and integrity in high temperature environments of at least 900° C. Additionally, an non-contact object heater 62 is positioned to direct heat onto the surface of the object 50. The non-contact object heater 62 is operated by the controller 30. Controller 30 is configured with programmed instructions stored in a non-transitory, computer readable medium so when the instructions are executed the controller generates signals for operating the non-contact object heater 62. For example, these signals selective couple and decouple the non-contact heater to an electrical power source and operate the electrical power source to adjust the electrical power supplied to the non-contact heater to achieve predetermined surface temperatures on object 50 being formed on the platform 38. The non-contact temperature probe 46 is operated as described previously to keep the surface temperature of the object 50 within a predetermined range. The non-contact object heater 62 may be an induction heater, a radiation heater, a convection heater, an infrared heater and the like.

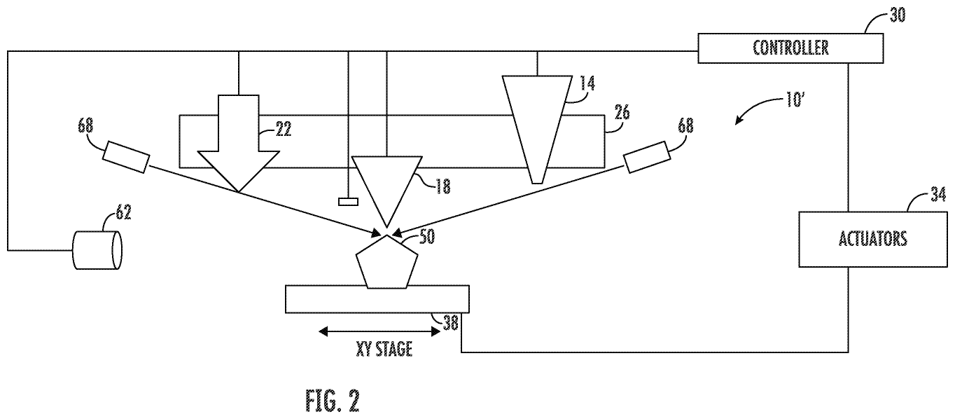

The embodiment 10′ shown in FIG. 2 includes one or more focused energy sources 68 that are operated by the controller 30. Controller 30 is configured with programmed instructions stored in a non-transitory, computer readable medium so when the instructions are executed the controller generates signals for operating the focused energy sources 68. For example, these signals selective couple and decouple the focused energy source to an electrical power source and operate the electrical power source to adjust the electrical power supplied to the focused energy to achieve predetermined surface temperatures on object 50 being formed on the platform 38. The focused energy sources 68 are operated as described with reference to the embodiment of FIG. 1 to keep the surface temperature of the object 50 within a predetermined range. The focused energy sources 68 may be a laser, such as a fiber laser, a diode laser, and the like. The type of laser and the wavelength of the laser are selected with reference to the material being used to form the object 50. Because the object is being heated at the point where the ejected melted metal drops land, the platform 38 does not require a heating element.

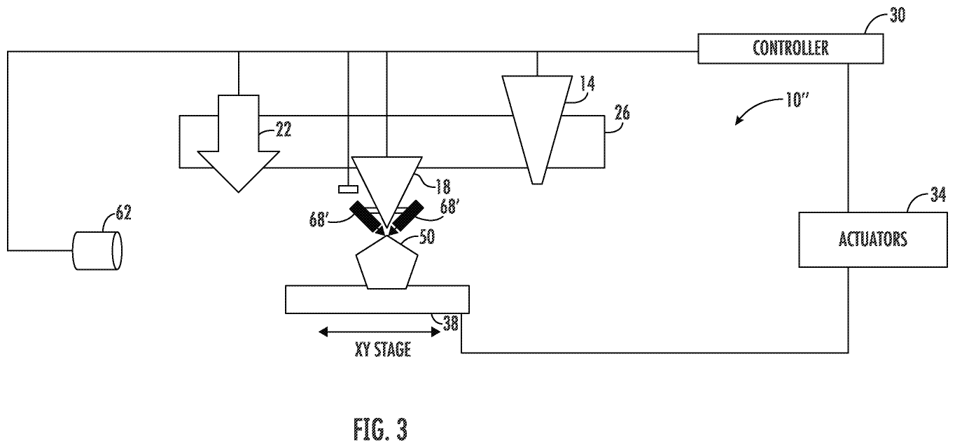

The embodiment 10″ shown in FIG. 3 includes a melted metal drop ejecting device 18′ that has one or more focused energy sources 68′ integrated into the device 18′. As used in this document, the term “integrated” means a first device is incorporated with a second device by being mounted directly to the second device or to structure extending from the second device. Because the melted drop ejecting device 18′ is an interchangeable module in the hybrid system, the integrated focused energy source can be swapped in and out of the system with the metal drop ejecting device. The controller 30 is configured with programmed instructions stored in a non-transitory, computer readable medium so when the instructions are executed the controller generates signals that are delivered to the device 18′ for operating the focused energy sources 68′. For example, these signals selective couple and decouple the focused energy source to an electrical power source and operate the electrical power source to adjust the electrical power supplied to the focused energy to achieve predetermined surface temperatures on object 50 being formed on the platform 38. The focused energy sources 68′ are operated as described with reference to the embodiment of FIG. 3 to keep the surface temperature of the object 50 within a predetermined range. The focused energy sources 68′ may be a laser, such as a fiber laser, a diode laser, a fiber coupled laser, and the like. The type of laser and the wavelength of the laser are selected with reference to the material being used to form the object 50.

The focused energy sources 68′ are positioned within the melted metal drop ejecting device 18′ to focus the energy beam at the spot where the ejected melted metal drops impact the surface of the object 50. This embodiment is more portable and is more compatible with many hybrid tools and systems. For example, because of the integration of melted metal drop ejecting device and focused energy sources, the integrated device 18′ can be used with many hybrid systems without requiring modifications to the hybrid manufacturing system. Furthermore, because the local heating caused by focused energy sources do not raise the overall part temperature significantly, the average part temperature is kept sufficiently low for many other tools to be used. For example, a CNC subtractive tool cannot typically be used for machining aluminum parts made with ejected melted metal drops because the temperature of the surface is too great. With local heating produced with integrated focused energy sources 68′, object 50 maybe be readily processed by CNC tool in this hybrid system because the average temperature of the object away from the area of focused heating is sufficiently low to enable machining operations. Additionally, the platform 38 may include the heating element 42 but as noted with respect to the embodiment shown in FIG. 2, the heating element 42 is not required.

It will be appreciated that variants of the above-disclosed and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the following claims.

What is claimed:

1. A metal hybrid manufacturing system comprising:
a platform;
a melted metal drop ejecting device coupled to a member, the melted drop ejecting device being configured to eject discrete melted metal drops toward the platform to form a metal object on the platform;
a tool coupled to the member, the tool being configured to either add metal or remove metal from the metal object being formed on the platform; and
a controller operatively connected to the melted metal drop ejecting device and the tool, the controller being configured to:
operate the melted metal drop ejecting device to form portions of the metal object on the platform; and
operate the tool to either shape or form other portions of the metal object being formed on the platform.

2. The metal hybrid manufacturing system of claim 1 wherein the tool is a metal deposition device.

3. The metal hybrid manufacturing system of claim 2 wherein the melted metal drop ejecting device is one of a magnetohydrodynamic ejector, an electrohydrodynamic ejector, a piston driven ejector and a pneumatic ejector.

4. The metal hybrid manufacturing system of claim 1 further comprising:
a heater configured to heat at least a portion of the object being formed on the platform.

5. The metal hybrid manufacturing system of claim 4 wherein the heater is one of a contact heater, an induction heater, a radiation heater, a convection heater, and an infrared heater.

6. The metal hybrid manufacturing system of claim 1 further comprising:
a focused energy source positioned to direct energy at a location on the object being formed on the platform where melted metal drops are to be ejected or metal deposited.

7. The metal hybrid manufacturing system of claim 6 wherein the focused energy source is a laser.

8. The metal hybrid manufacturing system of claim 7 wherein the laser is one of a fiber laser, a fiber coupled laser, and a diode laser.

9. The metal hybrid manufacturing system of claim 6 wherein the melted metal drop ejecting device and the focused energy source are integrated.

10. The metal hybrid manufacturing system of claim 1, the platform further comprising:
a heating element operatively connected to the controller.

11. A metal hybrid manufacturing system comprising:
a platform;
a member;
a melted metal drop ejecting device mounted to the member, the melted metal drop ejecting device configured to eject discrete melted metal drops toward the platform to form a metal object on the platform;
a tool mounted to the member, the tool being configured to either add or remove metal from the metal object on the platform;
a heater configured to heat at least a portion of the metal object being formed on the platform; and
a controller operatively connected to the melted metal drop ejecting device, the tool, and the heater, the controller being configured to:
operate the melted metal drop ejecting device to form portions of a metal object on the platform;
operate the heater to heat the metal object on the platform; and
operate the tool to shape or form other portions of the metal object on the platform.

12. The metal hybrid manufacturing system of claim 11 wherein the tool is a metal deposition device.

13. The metal hybrid manufacturing system of claim 12 wherein the metal deposition device is a directed energy deposition device.

14. The metal hybrid manufacturing system of claim 13 wherein the melted metal drop ejecting device is one of a magnetohydrodynamic ejector, an electrohydrodynamic ejector, a piston driven ejector and a pneumatic ejector.

15. The metal hybrid manufacturing system of claim 14 further comprising:
another tool mounted to the frame, the other tool being configured to remove metal from the metal object on the platform.

16. The metal hybrid manufacturing system of claim 15 wherein the heater is one of a contact heater, an induction heater, a radiation heater, a convection heater, and an infrared heater.

17. The metal hybrid manufacturing system of claim 14 further comprising:
a focused energy source positioned to direct energy at a location on the metal object being formed on the platform where melted metal drops are to be ejected or metal deposited.

18. The metal hybrid manufacturing system of claim 17 wherein the focused energy source is a laser.

19. The metal hybrid manufacturing system of claim 18 wherein the laser is one of a fiber laser, a fiber coupled laser, and a diode laser.

20. The metal hybrid manufacturing system of claim 17 wherein the melted metal drop ejecting device and the focused energy source are integrated.
